(19) United States
(12) Patent Application Publication
(10) Pub. No.: US 2026/0171460 A1
(43) Pub. Date: Jun. 18, 2026

(54) MANUFACTURING APPARATUS AND MANUFACTURING METHOD OF BATTERY

(71) Applicant: SK ON CO., LTD., Seoul (KR)

(72) Inventor: Dong Hyeon OH, Daejeon (KR)

(21) Appl. No.: 19/409,614

(22) Filed: Dec. 4, 2025

(30) Foreign Application Priority Data
Dec. 16, 2024 (KR) 10-2024-0187231

(51) Int. Cl. H01M 10/04; H01M 50/103; H01M 50/15

(52) U.S. Cl. CPC H01M 10/0404; H01M 10/049; H01M 50/103; H01M 50/15

(57) ABSTRACT

An apparatus of manufacturing a battery includes a first gripping portion gripping a hollow case with both ends thereof open and moving the case, a second gripping portion gripping and moving a cap assembly or an electrode assembly, and a controller controlling at least one of the first gripping portion or the second gripping portion to assemble the case and one of the cap assembly and the electrode assembly, wherein the controller controls an operation of the first gripping portion and the second gripping portion to assemble the case with one of the cap assembly and the electrode assembly in a state in which the both ends thereof open of the case are arranged vertically.

### CROSS-REFERENCE TO RELATED APPLICATION(S)

This patent document claims the priority and benefits of Korean Patent Application No. 10-2024-0187231 filed on Dec. 16, 2024, the disclosure of which is incorporated herein by reference in its entirety.

### TECHNICAL FIELD

The disclosure and implementations disclosed in this patent document generally relate to a battery manufacturing apparatus and method.

### BACKGROUND

Unlike primary batteries, which are used only once, secondary batteries may be recharged repeatedly and thus may be used multiple times.

Secondary batteries have been used in a variety of fields, including digital cameras, mobile phones, laptops, hybrid vehicles, electric vehicles, and energy storage systems (ESS).

Secondary batteries may be lithium-ion batteries, lithium polymer batteries, lead-acid batteries, nickel-metal hydride (NiMH), nickel-cadmium (NiCd), or all-solid-state batteries.

During a secondary battery manufacturing process, an electrode assembly, a case, and a cap are fixed by pre-welding.

According to the related art, in the process, the electrode assembly is inserted into a case in a lying position, and then cap plates are simultaneously inserted from both sides of the case to assemble the battery.

### SUMMARY

The present disclosure may be implemented in some embodiments to provide a battery manufacturing apparatus and method, capable of improving the assemblability of a case and an electrode assembly.

The present disclosure may also be implemented in some embodiments to provide a battery manufacturing apparatus and method, capable of reducing a defect rate in a manufacturing process of a case and an electrode assembly.

In some embodiments of the present disclosure, an apparatus of manufacturing a battery includes: a first gripping portion gripping a hollow case with both ends thereof open and moving the case; a second gripping portion gripping and moving a cap assembly or an electrode assembly; and a controller controlling at least one of the first gripping portion or the second gripping portion to assemble the case and one of the cap assembly and the electrode assembly, wherein the controller controls an operation of the first gripping portion and the second gripping portion to assemble the case with one of the cap assembly and the electrode assembly in a state in which the both ends thereof open of the case are arranged vertically.

The first gripping portion may rotate the case upside down.

The apparatus may further include: a release prevention support for mounting and supporting the case.

The cap assembly may include a cap plate and an electrode terminal protruding from one surface of the cap plate, the release prevention support may include a first mounting portion on which the case or the cap plate is mounted; and a second mounting portion on which the electrode terminal is mounted.

The release prevention support may include: a first protrusion protruding upwardly along an outer circumferential surface of the first mounting portion; and a second protrusion protruding upwardly along an outer circumferential surface of the second mounting portion, wherein the second protrusion is provided between the first mounting portion and the second mounting portion.

The release prevention support may include an opening provided to penetrate through a center of the second mounting portion vertically.

The electrode assembly may have electrode pins at both ends, the cap assembly may include a pin hole through which the electrode pin passes, and the opening may be provided to be larger than the pin hole and smaller than the electrode terminal.

The apparatus may further include a sensing unit capable of identifying a position of the cap assembly and a position of the electrode assembly, wherein the controller controls the first gripping portion and the second gripping portion based on the position of the cap assembly and the position of the electrode assembly received from the sensing unit.

The electrode assembly may include electrode pins at both ends, the cap assembly may have a pin hole through which the electrode pin passes, and the sensing unit may detect positions of a center of the electrode pin and a center of the pin hole.

The sensing unit may detect the position of the center of the electrode pin and the center of the pin hole through the opening.

In some embodiments of the present disclosure, a method of manufacturing a battery includes: assembling a first opening of a case having the first opening and a second opening and a first cap assembly; assembling an electrode assembly through the second opening of the case; and assembling a second cap assembly into the second opening of the case, wherein the case, the first cap assembly, the electrode assembly, and the second cap assembly are assembled in a state in which the first opening and the second opening of the case are arranged vertically.

The assembling of the electrode assembly may further include aligning the case and the electrode assembly, and the aligning of the case and the electrode assembly may include aligning the case and the electrode assembly by detecting, by a sensor, an electrode pin provided in the electrode assembly and a center of a pin hole, into which the electrode pin is inserted, provided in the first cap assembly.

### BRIEF DESCRIPTION OF DRAWINGS

Certain aspects, features, and advantages of the present disclosure are illustrated by the following detailed description with reference to the accompanying drawings.

FIG. 1 is a perspective view of a battery according to an embodiment of the present disclosure;

FIG. 2 is an exploded perspective view of a battery according to an embodiment of the present disclosure;

FIG. 3 is a block diagram of a battery manufacturing apparatus according to an embodiment of the present disclosure;

FIG. 4 is a plan view and a cross-sectional view of a release prevention support of a battery manufacturing apparatus according to an embodiment of the present disclosure;

FIG. 5 is a plan view and a cross-sectional view of a release prevention support of a battery manufacturing apparatus according to an embodiment of the present disclosure;

FIG. 6 is a state diagram of a battery manufacturing apparatus gripping a case according to an embodiment of the present disclosure;

FIG. 7 is a state diagram of a battery manufacturing apparatus assembling a first cap assembly and a case according to an embodiment of the present disclosure;

FIG. 8 is a state diagram of a battery manufacturing apparatus rotating a case to which a first cap assembly is coupled according to an embodiment of the present disclosure;

FIG. 9 is a state diagram of a battery manufacturing apparatus assembling an electrode assembly and a case according to an embodiment of the present disclosure;

FIG. 10 is a diagram illustrating a process of aligning an electrode assembly and a case according to an embodiment of the present disclosure;

FIG. 11 is a state diagram of a battery manufacturing apparatus assembling a second cap assembly and a case according to an embodiment of the present disclosure;

FIG. 12 is a state diagram illustrating a process of pre-welding a second cap assembly and a case according to an embodiment of the present disclosure; and

FIG. 13 is a flowchart of a battery manufacturing method according to an embodiment of the present disclosure.

### DETAILED DESCRIPTION

Prior to the description of the present disclosure, terms and words used in the present specification and claims to be described below should not be construed as limited to ordinary or dictionary terms, and should be construed in accordance with the technical idea of the present disclosure based on the principle that the inventors may properly define their own disclosures in terms of terms in order to best explain the disclosure. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, preferred embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. For the same reason, some of the elements in the accompanying drawings are exaggerated, omitted, or schematically illustrated, and the size of each element does not entirely reflect the actual size. In addition, in the present specification, the expressions, such as an upper side, a lower side, a side face, and the like, are described based on the drawings and may be expressed differently when the direction of the corresponding object is changed.

The present disclosure will be described in detail with reference to the accompanying drawings. However, this is merely illustrative and the present disclosure is not limited to the specific embodiments described by way of example.

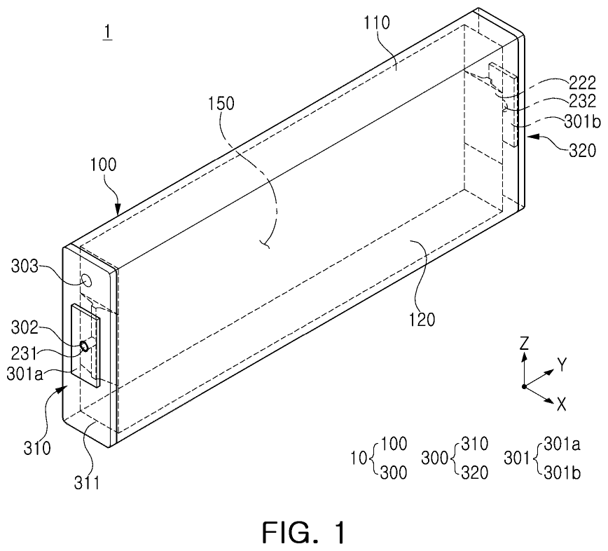

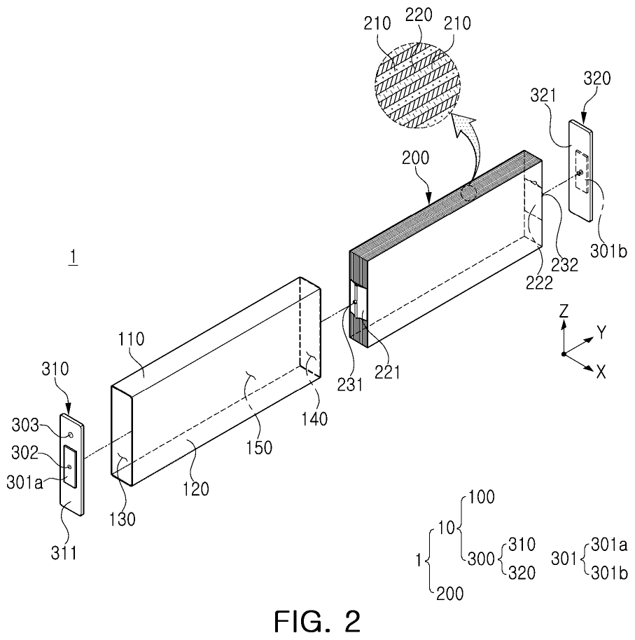

FIG. 1 is a perspective view of a battery according to an embodiment of the present disclosure, and FIG. 2 is an exploded perspective view of the battery according to an embodiment of the present disclosure.

Referring to FIGS. 1 and 2, a battery cell 1 may include a cell housing 10 including a case 100 and a cap assembly 300 and an electrode assembly 200 accommodated in an accommodation portion 150 formed by the cell housing 10.

The cell housing 10 may include a case 100 having an open structure at both ends and a pair of cap assemblies 300 coupled to the open both ends of the case 100.

The case 100 may form at least a portion of the cell housing 10 of the battery cell 1 and may be coupled to the cap assembly 300 to form the accommodation portion 150 accommodating the electrode assembly 200. The case 100 includes the accommodation portion 150 and may accommodate the electrode assembly 200 in the accommodation portion 150.

Here, the accommodation portion 150 may accommodate an electrolyte together with the electrode assembly 200.

The case 100 may be formed of aluminum.

The case 100 may have a substantially rectangular parallelepiped shape in which at least a portion is open.

For example, the case 100 may have a rectangular parallelepiped shape with both ends open, formed by coupling a first side surface 110 and a second side surface 120 having a width greater than the first side surface 110.

Here, the longitudinal direction (the Y-direction) of an edge at which the first side surface 110 and the second side surface 120 are coupled may be referred to as a longitudinal direction of the case 100 or a longitudinal direction of the battery cell 1. Furthermore, a direction (the X-direction) in which the first side surface 110 extends from the edge at which the first side surface 110 and the second side surface 120 are joined may be referred to as a thickness direction of the case 100 or a thickness direction of the battery cell 1. Furthermore, a direction (the Z-direction) in which the second side surface 120 extends from the edge at which the first side surface 110 and the second side surface 120 are coupled may be referred to as a width direction of the case 100 or a width direction of the battery cell 1.

The case 100 may be formed as a hollow hexahedron, including the first side surface 110 and the second side surface 120, extending in the longitudinal direction of the battery cell 1 and having open ends.

Here, one of both ends thereof open of the case 100 may be referred to as a first opening 130, and the other end may be referred to as a second opening 140.

The cell housing 10 may include a pair of cap assemblies 300, and the cap assemblies 300 may be coupled to the first opening 130 and the second opening 140 of the case 100, respectively.

Among the cap assemblies 300, the cap assembly 300 coupled to one end of the case 100 may be referred to as a first cap assembly 310, and the cap assembly 300 coupled to the other end may be referred to as a second cap assembly 320.

In other words, the first cap assembly 310 may be coupled to the first opening 130 of the case 100, and the second cap assembly 320 may be coupled to the second opening 140 of the case 100.

Referring to the structure of the electrode assembly 200 in more detail, the electrode assembly 200 may include an electrode plate 210, a separator, and an electrode tab 220.

The electrode plate 210 may include a first electrode plate and a second electrode plate having different polarities, and the separator may be an insulator interposed between a negative electrode plate and a positive electrode plate.

Here, one of the first and second electrode plates 210 may be a positive electrode plate, and the other may be a negative electrode plate.

The electrode assembly 200 may be configured such that the first and second electrode plates having different polarities and the separator are repeatedly arranged.

The electrode assembly 200 may be a winding type, a stacking type, a Z-folding type, or a stack-folding type electrode assembly.

Each electrode plate 210 may have a structure in which a negative electrode active material or a positive electrode active material is coated on a foil.

For example, the negative electrode plate may be formed by coating graphite or other materials on a copper or nickel foil, and the positive electrode plate may be formed by coating a transition metal oxide active material on an aluminum foil.

The electrode tab 220 may be configured to electrically connect a plurality of first electrode plates and a plurality of second electrode plates, respectively.

For example, at least two electrode tabs 220 may be provided, one of which may be electrically coupled to the first electrode plates, and the other may be electrically coupled to the second electrode plates.

Here, the electrode tab 220 electrically coupled to the first electrode plates may be referred to as a first electrode tab 221, and the electrode tab 220 electrically coupled to the second electrode plates may be referred to as a second electrode tab 222.

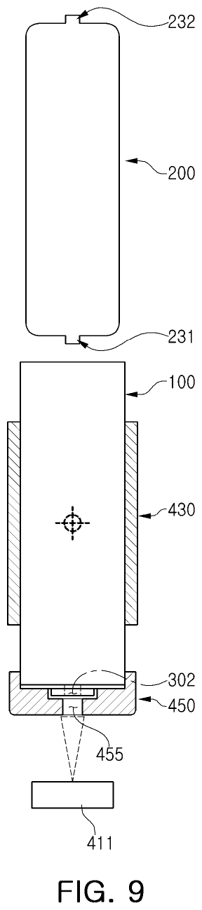

Here, the first electrode tab 221 and the second electrode tab 222 may be provided in combination with an electrode pin 230. The electrode pin 230 electrically coupled to the first electrode tab 221 may be referred to as a first electrode pin 231, and the electrode pin 230 electrically coupled to the second electrode tab 222 may be referred to as a second electrode pin (232 in FIG. 9).

The cap assembly 300 may include a cap plate coupled to the case 100 and sealing the case 100 with at least one open side.

Cap plates 311 and 312 may be formed of aluminum or a material including aluminum. The cap plates 311 and 312 may be laser-welded to the case 100 along the edges thereof.

The cap plate provided on one of the first cap assembly 310 or the second cap assembly 320 may include an electrolyte injection port 303 for injecting electrolyte into the cell housing 10.

Here, the electrolyte injection port 303 may be sealed with a stopper or the like after the electrolyte is injected.

Here, the cap plate coupled to the first cap assembly 310 may be referred to as a first cap plate 311, and the cap plate coupled to the second cap assembly 320 may be referred to as a second cap plate 321.

The cap assembly 300 may include an electrode terminal 301 provided on the opposite surface of surfaces of the cap plates 311 and 312 facing the inside of the case 100.

The electrode terminal 301 may have a positive or negative polarity. The electrode terminal 301 may include a first electrode terminal and a second electrode terminal.

For example, the first electrode terminal disposed on the first cap assembly 310 may have a negative polarity, and the second electrode terminal disposed on the second cap assembly 320 may have a positive polarity.

Here, the first electrode terminal 301a may be electrically connected to the negative plate via the first electrode tab 221, and the second electrode terminal 301b may be electrically connected to the positive plate via the second electrode tab 222.

Furthermore, the first electrode terminal 301a disposed on the first cap assembly 310 may have a positive polarity, and the second electrode terminal 301b disposed on the second cap assembly 320 may have a negative polarity.

Here, the first electrode terminal 301a may be electrically connected to the positive electrode plate via the first electrode tab 221, and the second electrode terminal 301b may be electrically connected to the negative electrode plate via the second electrode tab 222.

The first electrode terminal 301a and the second electrode terminal 301b may have pin holes 302 through which the electrode pin 230 may pass.

The components of the cap assembly 300 described above are examples, and thus, some components of the cap assembly 300 may be omitted, or other components not described may be added.

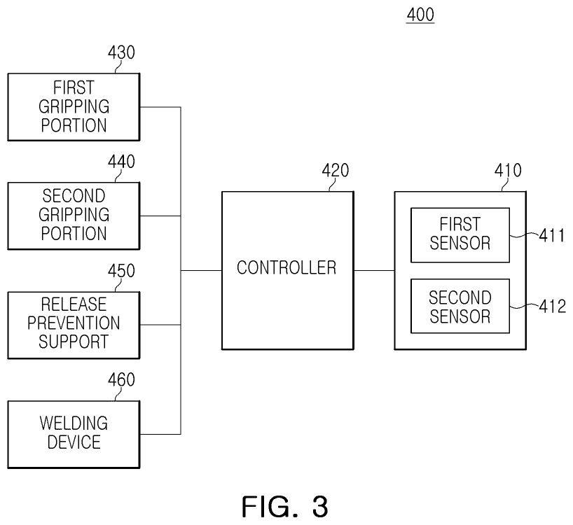

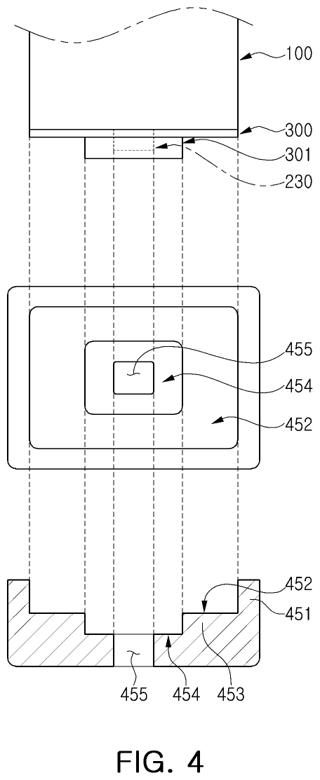

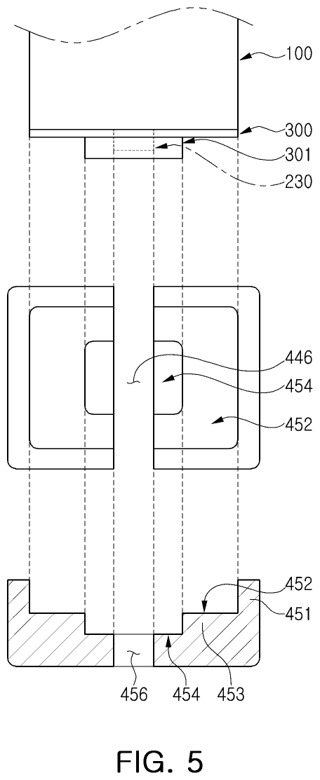

FIG. 3 is a block diagram of a battery manufacturing apparatus according to an embodiment of the present disclosure. FIG. 4 is a plan view and a cross-sectional view of a release prevention unit of the battery manufacturing apparatus according to an embodiment of the present disclosure. FIG. 5 is a plan view and a cross-sectional view of the release prevention unit of the battery manufacturing apparatus according to an embodiment of the present disclosure.

Referring to FIG. 3, a battery manufacturing apparatus according to an embodiment of the present disclosure may include a first gripping portion 430, a second gripping portion 440, a sensing unit 410, and a controller 420.

The battery manufacturing apparatus may include a first gripping portion 430 gripping and moving a hollow case 100 with both ends open, a second gripping portion 440 gripping and moving the cap assembly 300 or the electrode assembly 200, and a controller 420 controlling at least one of the first gripping portion 430 and the second gripping portion 440 to assemble the case 100 and one of the cap assembly 300 and the electrode assembly 200. The controller 420 may control the operation of the first gripping portion 430 and the second gripping portion 440 to assemble the case 100 with one of the cap assembly 300 and the electrode assembly 200 while the open both ends of the case 100 are arranged vertically.

The first gripping portion 430 and the second gripping portion 440 may be units capable of gripping an object (e.g., a case 100, a cap assembly 300, etc.) by applying pressure from both sides.

The first gripping portion 430 and the second gripping portion 440 may be configured as a multi-degree-of-freedom robot, a manipulator, or a combination of multiple orthogonal robots and may move the gripped object up, down, left, and right, as well as rotate the gripped object.

The second gripping portion 440 may grip the cap assembly 300 and move the first cap assembly 310 or the second cap assembly 320 to be placed in the first opening 130 or the second opening 140 of the case 100.

The battery manufacturing apparatus 400 according to an embodiment of the present disclosure may further include a release prevention support 450 for securing and supporting the case 100.

The first gripping portion 430 may grip the case 100 and rotate the case 100. The first gripping portion 430 may grip the case 100 and secure the case 100 on the release prevention support 450.

The first gripping portion 430 may rotate the case 100 to invert the case 100.

The release prevention support 450 may be configured to support the case 100 or the cell housing 10 during the assembly process of the battery cell 1.

Referring to FIG. 4, the release prevention support 450 may include a first mounting portion 452, a second mounting portion 454, a first protrusion 451, a second protrusion 453, and an opening 455.

The cap assembly 300 may include the cap plates 311 and 321 and the electrode terminals 301 protruding from one surface of the cap plates 311 and 321. The release prevention support 450 may include the first mounting portion 452 on which the case 100 or the cap plates 311 and 321 are mounted and the second mounting portion 454 on which the electrode terminal 301 is mounted.

The release prevention support 450 may include the first protrusion 451 protruding upwardly along an outer circumferential surface of the first mounting portion 452 and the second protrusion 453 protruding upwardly along an outer circumferential surface of the second mounting portion 454. The second protrusion 453 may be provided between the first mounting portion 452 and the second mounting portion 454.

The first mounting portion 452 may be configured to allow the case 100 or the case 100 coupled to the cap assembly 300 to be mounted thereon. The first mounting portion 452 may have a cross-section equal to or larger than the cross-section of the case 100 or the cap assembly 300.

Furthermore, the first protrusion 451 may protrude along the outer circumferential surface of the first mounting portion 452 toward the side in which the case 100 is mounted. A protruding surface of the first protrusion 451 may support a portion of a side surface of the case 100, thereby preventing the case 100 from moving left and right during an assembling process.

The second mounting portion 454 may be configured to allow the electrode terminal 301 to be mounted thereon and may be connected to the second protrusion 453 protruding along the outer circumferential surface of the second mounting portion 454 toward the side in which the case 100 is mounted.

The second mounting portion 454 may have the same size as or larger than the electrode terminal 301, and the second protrusion 453 may protrude higher than the height of the electrode terminal 301 protruding from the cap assembly 300.

Through this, the case 100 with the outwardly protruding electrode terminal 301 may be stably mounted on the first mounting portion 452.

In addition, the release prevention support 450 may include the opening 455 provided to penetrate through the center of the second mounting portion 454 vertically.

The electrode assembly 200 may include the electrode pins 230 at both ends, and the cap assembly 300 may include a pin hole 302 through which the electrode pins 230 pass. The opening 455 may be larger than the pin hole 302 and smaller than the electrode terminal 301.

Through this, in the case 100 in which the cap assembly 300 and electrode assembly 200 are assembled, the release prevention support 450 may stably secure and support the case 100 from below, despite the electrode terminal 301 coupled to protrude from one side of the cap assembly 300. Furthermore, the positions of the pin hole 302 and the electrode pin 230 may be detected and aligned through the opening 455.

The opening 455 may be configured to help detect the position of the electrode pin 230 penetrating through the electrode terminal 301. The battery manufacturing apparatus 400 may identify the positions of the pin hole 302 and the electrode pin 230 provided in the electrode terminal 301 through the opening 455, thereby aligning the case 100 in which the electrode assembly 200 and the cap assembly 300 are coupled.

Referring to FIG. 5, the release prevention support 450 according to an embodiment of the present disclosure may be provided as two release prevention supports based on a cutout portion 456.

The first mounting portion 452, the second mounting portion 454, the first protrusion 451, and the second protrusion 453 have similar structure to the release prevention support 450 described above, and thus, a detailed description thereof may be omitted.

The release prevention support 450 may have two body portions based on the cutout portion 456. The width of the cutout portion 456 may be at least greater than the thickness of the pin hole 302 and may perform the same function as that of the opening 455 described above.

Referring back to FIG. 3, the battery manufacturing apparatus according to an embodiment may further include a sensing unit 410 capable of identifying the position of the cap assembly 300 and the position of the electrode assembly 200. The controller 420 may control the first gripping portion 430 and the second gripping portion 440 based on the position of the cap assembly 300 and the position of the electrode assembly 200, received from the sensing unit 410.

The electrode assembly 200 may include the electrode pins 230 at both ends, and the cap assembly 300 may include the pin holes 302 through which the electrode pins 230 pass. The sensing unit 410 may detect the positions of the centers of the electrode pins 230 and the pin holes 302.

The sensing unit 410 may detect the positions of the center of the electrode pin 230 and the center of the pin hole 302 through the opening 455.

The sensing unit 410 may include a first sensor 411 and a second sensor 412.

The first sensor 411 may be provided below the release prevention support 450 and may detect the positions of the pin hole 302 of the cap assembly 300 and the electrode pin 230 of the electrode assembly 200.

The first sensor 411 may be a vision sensor, and edge information may be extracted from vision information received through the first sensor 411 to identify the position of the pin hole 302 provided in the electrode terminal 301 and the position of the electrode pin 230 of the electrode assembly 200 through the opening 455 of the release prevention support 450.

The second sensor 412 may be provided on the second gripping portion 440, may identify the position of the electrode pin 230 of the electrode assembly 200 disposed in an accommodation space of the case 100 mounted on the release prevention support 450, and may also identify the position of the pin hole 302 of the cap assembly 300.

The second sensor 412 may be a vision sensor, and edge information may be extracted from vision information received through the second sensor 412 to identify the position of the electrode pin 230 of the electrode assembly 200 through the pin hole 302 of the cap assembly 300.

The controller 420 controls the first gripping portion 430 and the second gripping portion 440 based on the detection results from the sensing unit 410, thereby assembling the cap assembly 300 to the case 100 or assembling the electrode assembly 200 to the case 100.

The controller 420 may be implemented via a non-volatile memory (not shown) configured to store data regarding an algorithm configured to control the operation of various components of the manufacturing apparatus or software instructions for reproducing the algorithm and a processor (not shown) configured to perform the operations described below using the data stored in the memory.

Here, the memory and processor may be implemented as separate chips. Alternatively, the memory and processor may be implemented as a single, integrated chip. The processor may take the form of one or more processors.

Referring back to FIG. 3, the battery manufacturing apparatus 400 according to the disclosure of the present invention may further include a welding device 460.

The welding device 460 may perform welding to couple the case 100 and the cap assembly 300 and may perform laser welding, spot welding, plasma welding, etc. The welding device may also perform pre-welding.

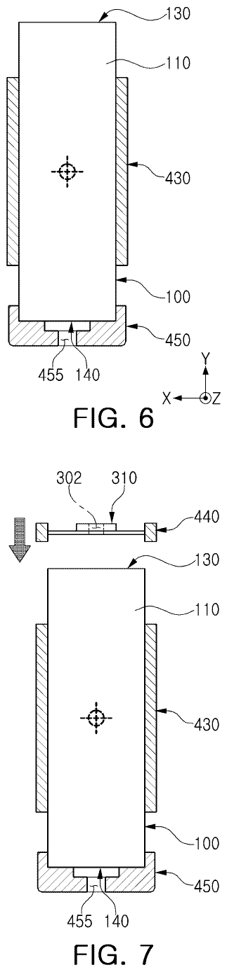

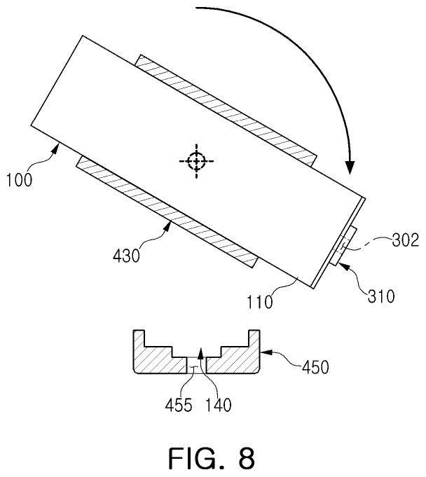

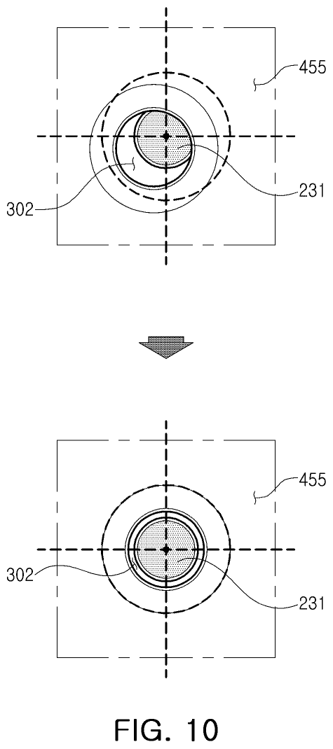

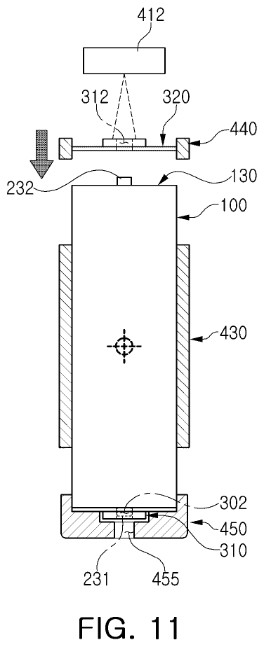

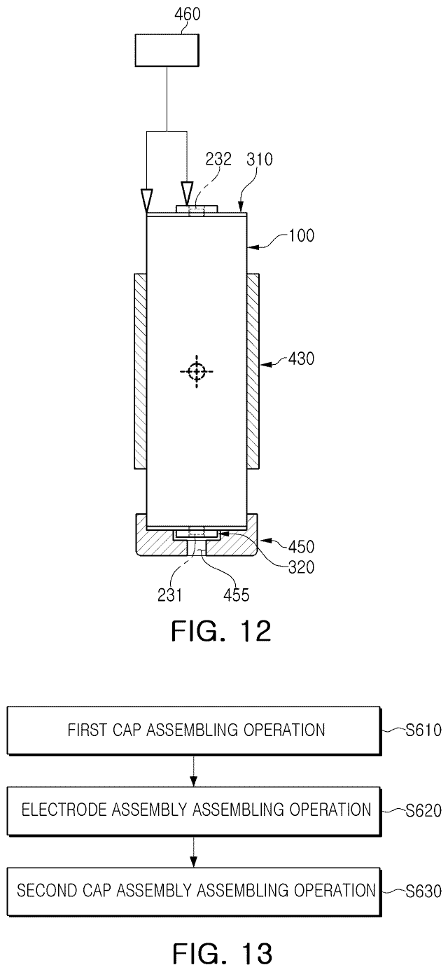

FIG. 6 is a state diagram of a battery manufacturing apparatus gripping the case 100 according to an embodiment of the present disclosure, FIG. 7 is a state diagram of a battery manufacturing apparatus assembling the first cap assembly 310 and the case 100 according to an embodiment of the present disclosure, FIG. 8 is a state diagram of a battery manufacturing apparatus rotating the case 100 to which the first cap assembly 310 is coupled according to an embodiment of the present disclosure, FIG. 9 is a state diagram of a battery manufacturing apparatus assembling the electrode assembly 200 and the case 100 according to an embodiment of the present disclosure, FIG. 10 is a diagram illustrating a process of aligning the electrode assembly 200 and the case 100 according to an embodiment of the present disclosure, FIG. 11 is a state diagram of a battery manufacturing apparatus assembling the second cap assembly 320 and the case 100 according to an embodiment of the present disclosure, and FIG. 12 is a state diagram illustrating a process of pre-welding the second cap assembly 320 and the case 100 according to an embodiment of the present disclosure.

A battery assembly process of the battery manufacturing apparatus 400 according to an embodiment of the present disclosure will be described in more detail with reference to FIGS. 6 to 12.

Referring to FIG. 6, the first gripping portion 430 may grip the case 100 by applying pressure to both sides of the case 100 and may allow one of the first opening 130 and the second opening 140 of the case 100 to be mounted on the release prevention support 450.

Hereinafter, the second opening 140 is described as being mounted on the release prevention support 450 first. However, without being limited thereto, and the first opening 130 may also be mounted on the release prevention support 450.

Unlike the battery manufacturing apparatus according to the related art that assembles battery cell 1 while lying down, the battery manufacturing apparatus 400 according to an embodiment of the present disclosure may assemble the battery cell 1 while standing the battery cell 1 up in the longitudinal direction.

In the battery manufacturing apparatus according to the related art, the electrode pin 230 of the electrode assembly 200 may not pass through the pin hole 302 of the cap assembly 300, or the area in which the battery cell 1 is placed is large, resulting in an increased working area.

In contrast, the battery manufacturing apparatus 400 according to an embodiment of the present disclosure aligns the electrode pins 230 of the electrode assembly 200 with the pin holes 302 of the cap assembly 300, thereby reducing assembly defects and improving equipment space efficiency.

Referring to FIG. 7, in the battery manufacturing apparatus 400, while the case 100 is mounted on the release prevention support 450, the second gripping portion 440 may grip the cap assembly 300 and couple the cap assembly 300 to the case 100.

More specifically, the second gripping portion 440 may grip the first cap assembly 310 and move the first cap assembly 310. The controller 420 may cause the second gripping portion 440 to move the first cap assembly 310 so that the first cap assembly 310 is coupled to the first opening 130 of the case 100.

Referring to FIG. 8, in a state in which the first cap assembly 310 grips the case 100 to which the first cap assembly 310 is coupled, the controller 420 may rotate the first gripping portion 430 so as to be upside down and may cause the first cap assembly 310 to be mounted on the release prevention support 450.

Here, the release prevention support 450 may include the first protrusion 451, the second protrusion 453, the first mounting portion 452, and the second mounting portion 454, so that the electrode terminal 301 may be mounted on the second mounting portion 454 and the case 100 may be stably supported on the protruding electrode terminal 301.

Referring to FIG. 9 along with FIG. 10, the controller 420 may cause the second gripping portion 440 gripping the electrode assembly 200 to be inserted into the accommodation portion 150 of the case 100 through the second opening 140.

Here, the first sensor 411 may identify the position of the pin hole 302 of the first cap assembly 310 and the first electrode pin 231 of the electrode assembly 200 through the opening 455 of the release prevention support 450.

The controller 420 may adjust the position of the electrode assembly 200 so that the center of the pin hole 302 and the center of the first electrode pin 231 are aligned.

The controller 420 may control the second gripping portion 440 to insert the electrode assembly 200 into the accommodation portion 150 of the case 100 while the center of the pin hole 302 and the center of the first electrode pin 231 are aligned.

Referring to FIG. 11 along with FIG. 10, the second sensor 412 may identify the position of the second electrode pin 232 of the electrode assembly 200 mounted in the accommodation portion 150, and the second gripping portion 440 may grip and move the second cap assembly 320.

The controller 420 may control the second gripping portion 440 to align the position of the second electrode pin 232 of the electrode assembly 200 with the pin hole 302 of the second cap assembly 320 via the second sensor 412.

The second gripping member 440 may couple the second opening 140 of the case 100 and the second cap assembly 320 in a state in which the position of the second electrode pin 232 of the electrode assembly 200 is aligned with the pin hole 302 of the second cap assembly 320.

Referring to FIG. 12, the welding device may pre-weld the second opening 140 of the case 100 and the second cap assembly 320 and may also pre-weld the electrode pin 230 and the electrode terminal 301.

Meanwhile, the welding device may also pre-weld the first opening 130 of the case 100 and the first cap assembly 310 even when the first opening 130 and the first cap assembly 310 are coupled, as illustrated in FIG. 7.

In this case, in addition to the release prevention support 450, a pre-weld portion may help couple the case 100 and the first cap assembly 310, thereby preventing the case 100 and the first cap assembly 310 from being released and firmly coupling the case 100 and the first cap assembly 310.

FIG. 13 is a flowchart of a battery manufacturing method according to an embodiment of the present disclosure.

Referring to FIG. 13, the battery manufacturing method according to an embodiment of the present disclosure may include a first cap assembly assembling operation (S610), an electrode assembly assembling operation (S620), and a second cap assembly assembling operation (S630).

More specifically, the battery manufacturing method according to an embodiment of the present disclosure includes an operation of assembling the first opening 130 of the case 100 including the first opening 130 and the second opening 140 and the first cap assembly 310, an operation of assembling the electrode assembly 200 through the second opening 140 of the case 100, and an operation of assembling the second opening 140 of the case 100 and the second cap assembly 320, and the case 100, the first cap assembly 310, the electrode assembly 200, and the second cap assembly 320 may be assembled in a state in which the first opening 130 and the second opening 140 of the case 100 are arranged vertically. The first cap assembly 310 assembling operation (S610) may be an operation of assembling the vertically placed case 100 and the first cap assembly 310.

The vertically placed case 100 assembled with the first cap assembly 310 may be rotated upside down so as to be assembled with the electrode assembly 200.

More specifically, in a state in which the first opening 130 of the case 100 is placed at the top, the case 100 may be assembled with the first cap assembly 310. After the first cap assembly 310 is assembled, the first cap assembly 310 may be rotated to be reversed so that the second opening 140 of the case 100 is disposed at the top.

Here, a portion of the case 100 and the first cap assembly 310 may be supported by the release prevention support 450 so as not to be separated from each other. Meanwhile, the case 100 and the first cap assembly 310 may be pre-welded in an assembled state.

The electrode assembly 200 assembling operation (S620) may be an operation of inserting the electrode assembly 200 into the accommodation portion 150.

The operation of assembling the electrode assembly 200 may further include an operation of aligning the case 100 and the electrode assembly 200.

In the operation of aligning the case 100 and the electrode assembly 200, the electrode pin 230 provided in the electrode assembly 200 and the center of the pin hole 302, into which the electrode pin is inserted, provided in the first cap assembly 310 are detected by the sensor and aligned.

The first sensor 411 may detect the electrode pin 230 of the electrode assembly 200 and the position of the pin hole 302 of the first cap assembly 310 through the opening 455 of the release prevention support 450 and ensure that the electrode pin 230 and the pin hole 302 align.

By assembling such that the electrode pin 230 and the pin hole 302 align through the first sensor 411, damage and defects that may occur during the assembly process due to misalignment between the electrode pin 230 and the pin hole 302 may be prevented.

In addition, by vertically inserting the electrode assembly 200 into the case 100, contact between the electrode assembly 200 and the case 100 may be minimized, thereby preventing damage or defects that may occur when the electrode assembly 200 moves along the side surface of the case 100 in the process of assembling the electrode assembly horizontally.

The second cap assembly 320 assembly operation (S630) may be an operation of assembling the second cap assembly 320 with the vertically placed case 100.

The case 100, assembled with the first cap assembly 310 and placed vertically, may have the electrode assembly 200 disposed in the accommodation portion 150 with the second opening 140 of the case 100 placed on the upper side.

The operation of assembling the second cap assembly 320 may further include assembling the case 100 and the second cap assembly 320.

In the operation of assembling the case 100 and the second cap assembly 320, the electrode pin 230 provided in the electrode assembly 200 and the center of the pin hole 302, into which the electrode pin 230 is inserted, provided in the second cap assembly 320 may be detected by the sensor and aligned.

The second sensor 412 may identify the electrode pin 230 of the electrode assembly 200 and the position of the pin hole 302 of the second cap assembly 320 and align the electrode pin 230 with the pin hole 302, thereby assembling the case 100 and the second cap assembly 320.

In the second cap assembly 320 assembly operation, the case 100 and the second cap assembly 320 may be pre-welded, and the pre-welded battery cell 1 may be transported for a subsequent process, such as main welding.

According to an embodiment of the present disclosure, the assembly performance of the case and electrode assembly may be improved.

Furthermore, according to an embodiment of the present disclosure, the defect rate in the manufacturing process of the case and electrode assembly may be reduced.

Furthermore, according to an embodiment of the present disclosure, the space efficiency of the manufacturing process of the case and electrode assembly may be improved.

The battery manufacturing apparatus of the present disclosure may be widely applied in green technology fields, such as electric vehicles, battery charging stations, and other solar and wind power generation using batteries.

Furthermore, the battery manufacturing apparatus of the present disclosure may be used in eco-friendly electric vehicles, hybrid vehicles, and other vehicles for preventing climate change by suppressing air pollution and greenhouse gas emissions.

The effects of the present disclosure are not limited to those described above, and other effects not mentioned will be clearly recognizable to those skilled in the art from the description below.

Only specific examples of implementations of certain embodiments are described. Variations, improvements and enhancements of the disclosed embodiments and other embodiments may be made based on the disclosure of this patent document.

What is claimed is:

1. An apparatus of manufacturing a battery comprising:
a first gripping portion gripping a hollow case with both ends thereof open and moving the case;
a second gripping portion gripping and moving a cap assembly or an electrode assembly; and
a controller controlling at least one of the first gripping portion or the second gripping portion to assemble the case and one of the cap assembly and the electrode assembly,
wherein the controller controls an operation of the first gripping portion and the second gripping portion to assemble the case with one of the cap assembly and the electrode assembly in a state in which the both ends thereof open of the case are arranged vertically.

2. The apparatus of claim 1, wherein the first gripping portion rotates the case upside down.

3. The apparatus of claim 1, further comprising a release prevention support for mounting and supporting the case.

4. The apparatus of claim 3, wherein
the cap assembly includes a cap plate and an electrode terminal protruding from one surface of the cap plate, and
the release prevention support includes:
a first mounting portion on which the case or the cap plate is mounted; and
a second mounting portion on which the electrode terminal is mounted.

5. The apparatus of claim 4, wherein
the release prevention support includes:
a first protrusion protruding upwardly along an outer circumferential surface of the first mounting portion; and
a second protrusion protruding upwardly along an outer circumferential surface of the second mounting portion,
wherein the second protrusion is provided between the first mounting portion and the second mounting portion.

6. The apparatus of claim 4, wherein the release prevention support includes an opening provided to penetrate through a center of the second mounting portion vertically.

7. The apparatus of claim 6, wherein
the electrode assembly has electrode pins at both ends,
the cap assembly includes a pin hole through which the electrode pin passes, and
the opening is provided to be larger than the pin hole and smaller than the electrode terminal.

8. The apparatus of claim 6, further comprising:
a sensing unit capable of identifying a position of the cap assembly and a position of the electrode assembly,
wherein the controller controls the first gripping portion and the second gripping portion based on the position of the cap assembly and the position of the electrode assembly received from the sensing unit.

9. The apparatus of claim 8, wherein
the electrode assembly includes electrode pins at both ends,
the cap assembly has a pin hole through which the electrode pin passes, and
the sensing unit detects positions of a center of the electrode pin and a center of the pin hole.

10. The apparatus of claim 9, wherein the sensing unit detects the position of the center of the electrode pin and the center of the pin hole through the opening.

11. A method of manufacturing a battery, the method comprising:
assembling a first opening of a case having the first opening and a second opening and a first cap assembly;
assembling an electrode assembly through the second opening of the case; and
assembling a second cap assembly into the second opening of the case,
wherein the case, the first cap assembly, the electrode assembly, and the second cap assembly are assembled in a state in which the first opening and the second opening of the case are arranged vertically.

12. The method of claim 11, wherein
the assembling of the electrode assembly further includes aligning the case and the electrode assembly, and
the aligning of the case and the electrode assembly includes aligning the case and the electrode assembly by detecting, by a sensor, an electrode pin provided in the electrode assembly and a center of a pin hole, into which the electrode pin is inserted, provided in the first cap assembly.
